(19) United States
(12) Patent Application Publication
(10) Pub. No.: US 2012/0263350 A1
(43) Pub. Date: Oct. 18, 2012

(54) METHOD FOR IDENTIFYING LOST OR UNASSIGNABLE LUGGAGE

(75) Inventor: Svetlozar Delianski, Berlin (DE)

(73) Assignee: SIEMENS AKTIENGESELLSCHAFT, MUENCHEN (DE)

(21) Appl. No.: 13/518,483

(22) PCT Filed: Dec. 2, 2010
(86) PCT No.: PCT/EP10/68696

§ 371 Date: Jun. 22, 2012

(30) Foreign Application Priority Data
Dec. 22, 2009 (DE) 10 2009 060 057.4

(51) Int. Cl. G06K 9/62

(52) U.S. Cl. 382/103

(57) ABSTRACT

A method identifies lost or non-assignable luggage, in particular air travel luggage, which is subjected to a security inspection after check-in by being channeled through an x-ray scanner and the x-ray images being analyzed. In order to improve and simplify the method for identifying lost or non-assignable luggage without mechanized effort, the x-ray images taken in the x-ray scanner, which contain details about the contents of the luggage, as well as assigned optically or electronically output information about the luggage are saved in a computer for later evaluation.

The invention relates to a method for identifying lost or unassignable luggage, in particular the luggage of air passengers, which is subjected to a security inspection after check-in, where it is passed through an X-ray scanner and the X-ray images are analyzed.

As the number of people traveling by air has steadily increased, so has the percentage of luggage that is wrongly directed, temporarily untraceable, and lost increased too. Approximately one percent of checked-in luggage causes problems during handling. It costs airlines several million dollars a year in compensation to replace lost or untraceable luggage. Moreover, lost suitcases have a significant effect on customer satisfaction.

Luggage is often lost because the labels attached to the luggage and including passenger-related information are torn off or become illegible when they are transported through the sorting unit and it is thus not possible to assign it to the correct flight. This luggage is first removed from the sorting unit and checked by hand. If it is still not possible to assign the luggage, the airline staff wait until the passenger asks for their missing luggage. In this case, passengers have to fill in a so-called lost luggage form (LLF) and choose, from a table with pictures of many different pieces of luggage, a piece of luggage that is similar to the luggage they have lost. This picture is used to look for the luggage.

These unsatisfactory processes result in high costs, bad press and a lot of time spent with little success. Increasingly, frustrated passengers try to take on board more and more luggage that they would previously have checked in, which in turn leads to delayed departures and discussions with the crew, and is often the cause of delayed departures.

U.S. Pat. No. 5,299,116 describes a method which also relates to unidentifiable luggage. It is proposed to store the data of the unassignable luggage in as much detail as possible in the computer of a workstation, along with a video image of the luggage. Later, airline staff can look for the missing luggage in a targeted fashion using the passenger's details and with the aid of the data and information (including the video images) stored in a database, and the luggage can be assigned to the rightful owner.

Although the known system makes it easier to assign the luggage, it does assume that it has been found but cannot be identified and that the staff are able to input information about this luggage into the computer.

An improved process is known from WO 2008/003609A1 for retrieving and identifying such luggage which can be unambiguously assigned to the passenger when it is checked in at the luggage desk.

It is proposed that, when the luggage is checked in and before it is forwarded into the luggage sorting unit, a photograph or video image is taken of each piece of luggage and stored electronically, together with the passenger's flight data, in the flight data computer at least for a predetermined period of time. Unlike in the above-described prior art, every piece of luggage is photographed and not just luggage that was lost later, and the photograph or video image taken is stored together with the passenger's flight data.

An image or a photograph of the piece of luggage he checked in is thus assigned to each passenger and can be called up from the computer at any time. The photographs make it easier to identify the luggage in a lost and found procedure, i.e. when a piece of luggage cannot be found, in particular when the luggage has been photographed from several sides beforehand.

However, the last described solution entails an investment in equipment as a camera needs to be installed at check-in that provides analyzable images or videos of each piece of luggage. If reliably analyzable images are desired, several cameras should be used to photograph the luggage from several sides and/or devices must be created which move the luggage into a correct position for photographing. It is difficult to make the assignment if similar-looking suitcases have been photographed.

The object of the present invention is to improve and simplify the method for identifying lost or unassignable luggage without an investment in equipment.

It is proposed according to the invention that the X-ray images taken in the X-ray scanner are stored in a computer, with details of the contents of the luggage and together with associated optically or electronically read information on the luggage, so that they can be analyzed later.

After check-in, all checked-in luggage undergoes a security inspection where it is passed through an X-ray scanner and the X-ray images are analyzed there on a screen. The X-ray images contain a lot of details on the contents of the luggage. It is appropriate to use the knowledge that exists after the X-raying about the contents of the luggage to draw conclusions about the identity of a specific piece of luggage and who owns it. There is no need for additional expenditure on equipment as the X-ray machines are present at all airports anyway. All that is required is to store the pictorial information obtained on the details of the contents of the luggage temporarily in a computer and to associate it with the information on the passenger, which can be found for example on the label of the suitcase, once the luggage has passed through the X-ray scanner. Within the sense of the invention, the term X-ray scanner should be understood to not be limited to X-ray units and also includes any scanner technology that makes the contents of luggage visible.

If the label is damaged or torn off altogether during the onward conveyance of the luggage, in one embodiment of the invention it is proposed, if the luggage has been wrongly identified or cannot be identified, to pass the luggage through the X-ray scanner again and to record the resulting X-ray images using the image processing methods for the first recording and supply them to the computer. The details of the contents of the luggage are thus recorded in such a way that the luggage can be unambiguously described using the X-ray image.

According to a further feature of the invention, the details recorded during the second X-raying on the contents of the luggage are compared with the details on the contents of all luggage recorded and stored in the computer during the first recordings. If there is a positive result from the comparison, the identity of the luggage can be determined and the luggage can be delivered to the passenger using the stored information assigned during the first recording.

According to the invention, the X-ray images produced electronically in a second passage through the X-ray scanner are matched with the aid of the object recognition in the automatic image processing. In this proposal, the X-ray images for each piece of luggage present electronically in the computer are automatically matched with the second X-ray pictures produced in terms of how they coincide, and are correctly assigned.

In order to minimize the volume of data, it is proposed according to a further feature of the invention that the stored information is stored for the maximum period of time expected for a passenger to collect the luggage and is then deleted. If an air passenger has not complained that he or she has not received his or her luggage within a foreseeable period of time, for example within one day after arrival at the destination airport, it is assumed that he or she has duly received his or her luggage. In this case, the information and especially the X-ray images of the luggage do not need to continue to be filed in the memory of the computer and can be deleted. In this way, only the current flight information, including the X-ray images of the luggage of these flights, needs to continue to be stored so that it is available to the ground crew in the event of identification being impossible, or to the lost and found office and the passengers in the event of an inquiry.

A further advantage of the method according to the invention is that, in the event of a piece of luggage being completely lost, the X-ray pictures taken at check-in can be used to assess the contents of luggage that needs to be replaced. If a piece of luggage can no longer be found, for example because it has been stolen, the airline is obliged to provide compensation. Because the airline has up until now relied solely on information given by the passenger about the value and the contents of their luggage, the replacement value was often greater than the actual value of the luggage and its contents.

The existing X-ray pictures can now be checked in order to identify what the contents of the lost luggage were when it was checked in at the luggage desk and the value of the luggage can be established more accurately.

Lastly, the method of the invention can be used to forward the X-ray images of a lost piece of luggage which are stored in the computer when the luggage passes through the X-ray scanner for the first time, and the associated passenger-related data, in order to search for the lost piece of luggage, to computers located elsewhere so that they can be matched with data stored there on found luggage. Thus, for example, the data on a piece of luggage that is being searched for can be sent electronically to other airports where there are unidentifiable pieces of luggage. Knowing the contents of the luggage being searched for, staff can compare them with the contents of luggage that has been found so that the piece of luggage can be returned to the right passenger.

Using relatively simple means, a method is provided by the invention that minimizes the expense that has hitherto been involved for identifying luggage with missing or illegible labels. Use is thus made of means that would be present anyway, namely X-ray scanners that, as well as their original purpose, are used to perform the identification that is lacking. It is thereby possible for the process to be largely automated. Additional advantages of the invention follow from the objective analysis of the contents of lost luggage. Airlines' compensation departments are thus better able to establish the actual damages for loss.

1-8. (canceled)

9. A method for identifying lost or unassignable luggage, including the luggage of air passengers, being subjected to a security inspection after check-in, where during a first recording the luggage is passed through an X-ray scanner and first X-ray images are analyzed, which comprises the step of:
storing the first X-ray images taken in the X-ray scanner in a computer, with details of contents of the luggage and with associated optically or electronically read information on the luggage, so that they can be analyzed later.

10. The method according to claim 9, which further comprises recording the details of the contents of the luggage using image processing methods such that the luggage can be unambiguously described using a first X-ray image.

11. The method according to claim 9, which further comprises if the luggage has been wrongly identified or cannot be identified, performing a second recording by passing the luggage through the X-ray scanner again and recording second X-ray images using image processing methods used in the first recording and supplying the second X-ray images to the computer.

12. The method according to claim 11, which further comprises comparing details recorded during the second X-raying on the contents of the luggage with the details on the contents of all luggage recorded and stored in the computer during the first recording.

13. The method according to claim 12, wherein if there is a positive result from a comparison, an identity of the luggage is determined and the luggage is delivered to a passenger using the information assigned during the first recording.

14. The method according to claim 12, wherein the second X-ray images produced electronically in the second recording through the X-ray scanner are matched with an aid of object recognition in an automatic image processing.

15. The method according to claim 9, which further comprises using the first X-ray images taken at check-in to assess the contents of luggage that needs to be replaced in an event the luggage is completely lost.

16. The method according to claim 9, which further comprises forwarding the first X-ray images of a lost piece of luggage stored in the computer when the luggage passes through the X-ray scanner for a first time, and associated passenger-related data, in order to search for the lost piece of luggage, to further computers located elsewhere so that the first X-ray images can be matched with data stored in the further computers relating to found luggage.
